(19) United States
(12) Patent Application Publication
(10) Pub. No.: US 2015/0190962 A1
(43) Pub. Date: Jul. 9, 2015

(54) THREE-DIMENSIONALLY SHAPED OBJECT AND APPRATUS AND MANUFACTURING METHOD FOR THREE-DIMENSIONALLY SHAPED OBJECT

(71) Applicant: Industrial Technology Research Institute, Hsinchu (TW)

(72) Inventors: Cheng-Chen Yang, Hsinchu City (TW); Yi-Chih Fan, Taoyuan County (TW); Chun-Hung Huang, Hsinchu County (TW)

(73) Assignee: Industrial Technology Research Institute, Hsinchu (TW)

(21) Appl. No.: 14/277,069

(22) Filed: May 14, 2014

(30) Foreign Application Priority Data
Jan. 6, 2014 (TW) 103100411

(51) Int. Cl. B29C 67/00

(52) U.S. Cl. CPC B29C 67/0055; B29L 2009/00

(57) ABSTRACT

A three-dimensionally shaped object and an apparatus and a method for manufacturing the three-dimensionally shaped object are provided. The apparatus for manufacturing the three-dimensionally shaped object includes a support module, a material supply module, and an energy source module. The support module is suitable for holding a semi-finished object. The material supply module supplies a powder material and attaches the powder material to a surface of the semi-finished object. The energy source module supplies a radiation source that irradiates the semi-finished object. The support module is adapted to rotate the semi-finished object, so that the powder material attached to the semi-finished object turns to face the energy source module and is irradiated by the radiation source to form a sintered layer. The powder material remains on the semi-finished object while the semi-finished object is rotated.

### CROSS-REFERENCE TO RELATED APPLICATION

This application claims the priority benefit of Taiwan application serial no. 103100411, filed on Jan. 6, 2014. The entirety of the above-mentioned patent application is hereby incorporated by reference herein and made a part of this specification.

### TECHNICAL FIELD

The technical field relates to a three-dimensionally shaped object and an apparatus and a manufacturing method for the three-dimensionally shaped object; more particularly, the technical field relates to a three-dimensionally shaped object having sintered layers that are stacked and an apparatus and a manufacturing method for the three-dimensionally shaped object.

### BACKGROUND

According to an additive manufacturing (AM) technology which is also referred to as three-dimensional (3D) printing, a 3D image is sliced into a series of two-dimensional (2D) layers, and the two-dimensional (2D) layers are overlaid to form a three-dimensionally shaped object.

Different from the conventional subtractive manufacturing technology (also referred to as a cutting-type manufacturing technology), the AM technology is applied to form the three-dimensionally shaped object by stacking the 2D profiles layer by layer, such that the time of manufacturing the complicated three-dimensionally shaped object may be reduced. Since the steps of performing several steps and switching the processing tools or equipment in the conventional subtractive manufacturing technology are omitted in the AM technology, the AM technology complies with the requirements for mass customization and significantly improves the manufacturing efficiency. What is more, issues occurred during the conventional manufacturing process may be resolved.

However, in the existing AM technology, a welding pool may be generated on the edge of the resultant three-dimensionally shaped object after a laser sintering process is performed, and thereby the size precision, the tolerance, and the roughness of the three-dimensionally shaped object cannot be effectively controlled. For instance, in the three-dimensionally shaped object, surfaces of inner channels or grooves with a large aspect ratio cannot be easily ground or polished. In another aspect, when a product having a complicated profile design is to be manufactured, different parts need to be fabricated individually and subsequently coupled together to form a sophisticated product, and thus the fabrication rate cannot be accelerated.

### SUMMARY

According to an exemplary embodiment of the disclosure, an apparatus for manufacturing a three-dimensionally shaped object is provided, and the apparatus includes a support module, a material supply module, and an energy source module. The support module is suitable for holding a semi-finished object. The material supply module supplies a powder material and attaches the powder material to a surface of the semi-finished object. The energy source module supplies a radiation source that irradiates the semi-finished object. Here, the support module is adapted to rotate the semi-finished object, such that the powder material attached to the semi-finished object turns to face the energy source module and is irradiated by the radiation source to form a sintered layer, and the powder material remains on the semi-finished object while the semi-finished object is rotated.

According to an exemplary embodiment of the disclosure, a method for manufacturing a three-dimensionally shaped object includes following steps. An apparatus for manufacturing the three-dimensionally shaped object is provided, and the apparatus includes a support module, a material supply module, and an energy source module. The support module is suitable for holding a semi-finished object. The semi-finished object is rotated by using the support module, such that the powder material from the material supply module is attached to a first region on the semi-finished object. The semi-finished object is rotated by the support module, such that the first region turns to face the energy source module and is irradiated by a radiation source, and the powder material attached to the first region is sintered along a predetermined path, so as to form a sintered layer.

According to an exemplary embodiment of the disclosure, a three-dimensionally shaped object that includes a semi-finished object and a plurality of sintered structures is provided. The sintered structures are formed on the semi-finished object. Here, the sintered structures include a first sintered portion and a second sintered portion. The first sintered portion is constituted by a plurality of first sintered layers stacked on the semi-finished object along a first direction. The second sintered portion is constituted by a plurality of second sintered layers stacked on the semi-finished object along a second direction, and the second direction is different from the first direction.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic view illustrating an apparatus for manufacturing a three-dimensionally shaped object according to an exemplary embodiment of the disclosure.

FIG. 2 is a schematic view illustrating the support module depicted in FIG. 1.

FIG. 3 is a schematic cross-sectional view illustrating the semi-finished object depicted in FIG. 1 along a sectional line I-I.

FIG. 4 is a side view of an apparatus for manufacturing a three-dimensionally shaped object according to another exemplary embodiment of the disclosure.

FIG. 5A is a schematic view illustrating a semi-finished object according to an exemplary embodiment of the disclosure.

FIG. 5B is a schematic cross-sectional view illustrating the semi-finished object depicted in FIG. 5A along a sectional line J-J.

FIG. 6A to FIG. 6C are flows illustrating an additive manufacturing (AM) process performed on the first region on the semi-finished object depicted in FIG. 5B with use of an apparatus for manufacturing a three-dimensionally shaped object.

FIG. 7 is a schematic three-dimensional view of FIG. 6A.

FIG. 8A illustrates a three-dimensionally shaped object formed by performing the manufacturing process depicted in FIG. 6A to FIG. 6C.

FIG. 8B is a schematic cross-sectional view of FIG. 8B along a sectional line K-K.

FIG. 9 illustrates a three-dimensionally shaped object formed by employing an apparatus for manufacturing a three-dimensionally shaped object according to another exemplary embodiment of the disclosure.

### DETAILED DESCRIPTION OF DISCLOSED EMBODIMENTS

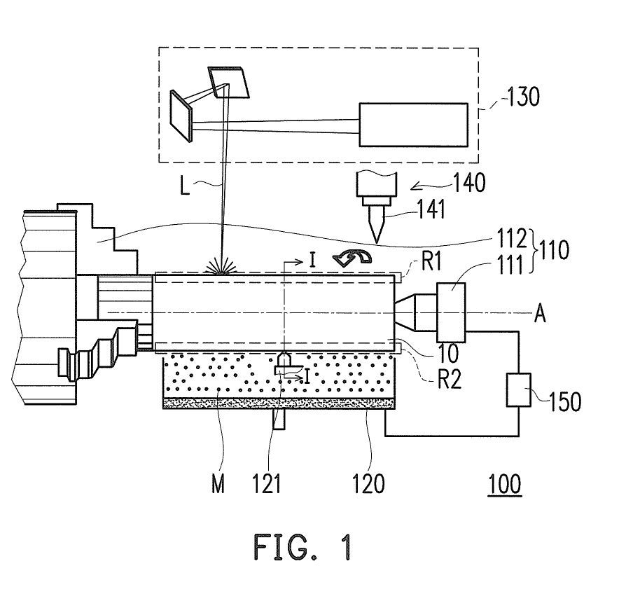

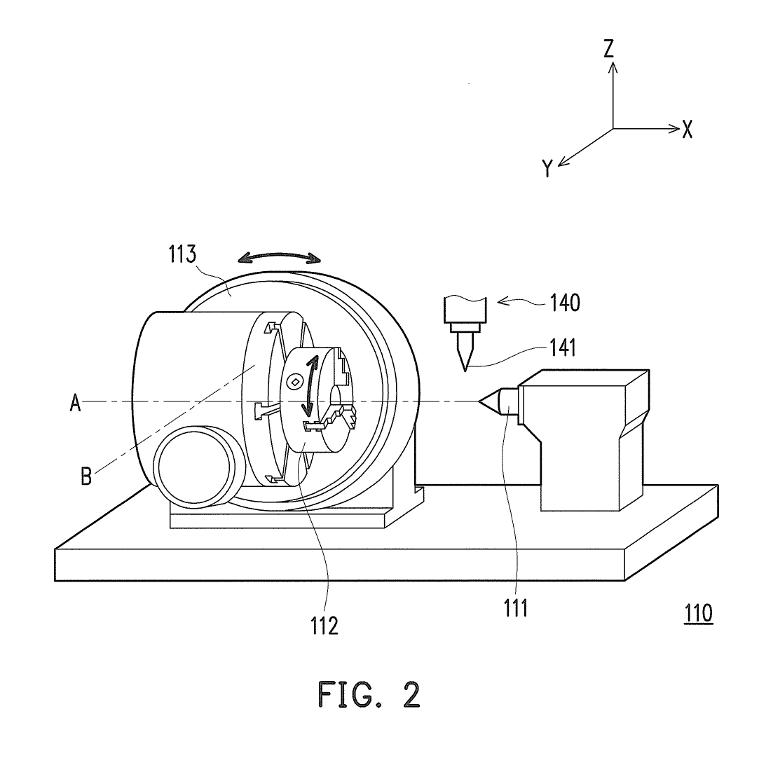

FIG. 1 is a schematic view illustrating an apparatus for manufacturing a three-dimensionally shaped object according to an exemplary embodiment of the disclosure. FIG. 2 is a schematic view illustrating the support module depicted in FIG. 1. With reference to FIG. 1 and FIG. 2, in the present exemplary embodiment, an apparatus 100 for manufacturing a three-dimensionally shaped object includes a support module 110, a material supply module 120, and an energy source module 130. The support module 110 is adapted to hold the semi-finished object 10 and may include a pushing member 111 and a holder 112. For instance, the holder 112 may be a pneumatic or hydraulic three jaw holder for holding one end of the semi-finished object 10. Although the holder 112 described herein is a three jaw holder, a four-jaw holder, a five jaw holder, or a six-jaw holder may be applied in other exemplary embodiments to hold the semi-finished object 10, which should not be construed as a limitation to the disclosure.

In another aspect, the semi-finished object 10 may not only be held by the holder 112 of the support module 110 but also be locked onto the support module by screws. Alternatively, the semi-finished object 10 may be lodged in a fixing device that can held open and thereby fixed onto the support module. The disclosure is not limited to the exemplary embodiments provided herein.

Particularly, a conventional three-axis machine includes three linear movement axes, i.e., the axes x, y, and z, and the support module 110 described in the present exemplary embodiment not only includes said three linear movement axes but also comprises a rotational axis A parallel to the axis x and the rotational axis B parallel to the axis y. The holder 112 is located on a stage 113 that may rotate about the rotational axis B; hence, when the holder 112 holds one end of the semi-finished object 10, but the pushing member 111 does not push the other end of the semi-finished object 10, the semi-finished object 10 is rotated about the rotational axis B passing the holder 112 within a predetermined angle range by rotating the stage 113. The holder 112 may also rotate about the rotational axis A; therefore, when the holder 112 holds one end of the semi-finished object 10, and the pushing member 111 pushes the other end of the semi-finished object 10, the rotation of the holder 112 allows the semi-finished object 10 to rotate about the rotational axis A by 360 degrees. In the event that the semi-finished object 10 is held by and fixed between the pushing member 111 and the holder 112, the semi-finished object 10 may rotate about the rotational axis A by 360 degrees in a more stable manner.

In another exemplary embodiment, the support module 110 may also be another type of five-axis machine, in which one of the two rotational axes is parallel to the axis z; therefore, in addition to the above movement, the support module 110 may include the three linear movement axes x, y and z, the rotational axis A parallel to the axis x, and a rotational axis (not shown) parallel to the axis z or include the three linear movement axes x, y, and z, the rotational axis B parallel to the axis Y, and a rotational axis (not shown) parallel to the axis Z. The disclosure is not limited to the exemplary embodiments provided herein. The apparatus 100 for manufacturing the three-dimensionally shaped object further includes a cutting and polishing module 140, and the cutting and polishing module 140 is equipped with a knife 141 adapted to perform a cutting or polishing process on the semi-finished object 10. The three linear movement axes x, y, and z of the support module 110 may determine the location where the knife 141 performs the cutting or polishing process, while the two rotational axes A and B may determine the cutting direction in which the knife 141 performs the cutting or polishing process.

As shown in FIG. 1 and FIG. 2, the semi-finished object 10 described herein has a bar-like shape, and a surface of at least one region on the semi-finished object 10 is non-planar; however, the disclosure is not limited thereto. In other exemplary embodiments, the semi-finished object 10 may have a spherical shape, an aspheric shape, or another shape. Namely, the semi-finished object 10 may have a 3D structure whose shape is not limited in the disclosure, and the shape of the semi-finished object 10 may be determined by performing the cutting or polishing process through the cutting and polishing module 140 or by performing another process and using other machine.

The material supply module 120 supplies a powder material M that may be metal powder or polymer powder. For instance, the material of the metal powder may be maraging steel, aluminum alloy, stainless steel, or titanium alloy, which should however not be construed as a limitation to the disclosure. The apparatus 100 for manufacturing the three-dimensionally shaped object further includes a power supply 150 electrically coupled between the support module 110 and the material supply module 120. When the semi-finished object 10 approaches the material supply module 120, the powder material M may be attached to the semi-finished object 10 through an electrostatic force. In the present exemplary embodiment, the material supply module 120 may provide the powder material M to the semi-finished object 10, and the powder material M may overlay the surface of the semi-finished object 10 in a layer-by-layer manner.

To be specific, the power supply 150 may output 1.5 KV to 10 KV high voltage power. One end of the power supply 150 is electrically coupled to the pushing member 111, while the other end is electrically coupled to the material supply module 120, such that the powder material M in the material supply module 120 carries charges. Therefore, when the semi-finished object 10 approaches the material supply module 120, the powder material M that is in the material supply module 120 and carries charges may be attached to the semi-finished object 10 through the electrostatic force.

If, for instance, the powder material M is the metal powder, the metal powder is attached to the semi-finished object 10 through a van der Waals force after the metal powder is in contact with the semi-finished object 10, and particles of the metal powder are attracted to one another through cohesion. In the present exemplary embodiment, the semi-finished object 10 may be further coated with a medium with high impedance, such as polyethylene (PE), polypropylene (PP), polyvinyl chloride (PVC), resin, or any other material with high impedance.

If, for instance, the powder material M is the polymer powder, the polymer powder, different from the metal powder as described in above, is attached to the semi-finished object 10 through the residual electrostatic force, and particles of the polymer powder are attracted to one another through the residual electrostatic force as well. In other words, although the particles of the polymer powder may be attracted to one another through cohesion, and the polymer powder may also be attached to the semi-finished object 10 through the van der Waals force, the cohesion and the van der Waals force are far weaker than the residual electrostatic force.

Due to the power supply 150, the polymer powder may also carry charges. Since the polymer powder is different from the metal powder in nature, the range of the high voltage power output by the power supply 150 may be adjusted according to actual requirements if the powder material M in the material supply module 120 is the polymer material.

From another perspective, even in case that the surface of at least one region on the semi-finished object 10 is non-planar, or the entire surface of the semi-finished object 10 is non-planar, the powder material M may still be attached to the non-planar surface through the electrostatic force. Namely, even if the surface of the semi-finished object 10 is not sufficiently planar, the processing speed may not be accordingly affected. According to the related art, a three-dimensionally shaped object may be formed merely by paving a planar surface with the powder material; in contrast thereto, the apparatus 100 for manufacturing the three-dimensionally shaped object as described herein may be applied in a more flexible manner. In the present exemplary embodiment, one end of the power supply 150 is electrically coupled to the pushing member 111; however, in another exemplary embodiment, one end of the power supply 150 may also be electrically coupled to the holder 112, which may be determined according to actual requirements.

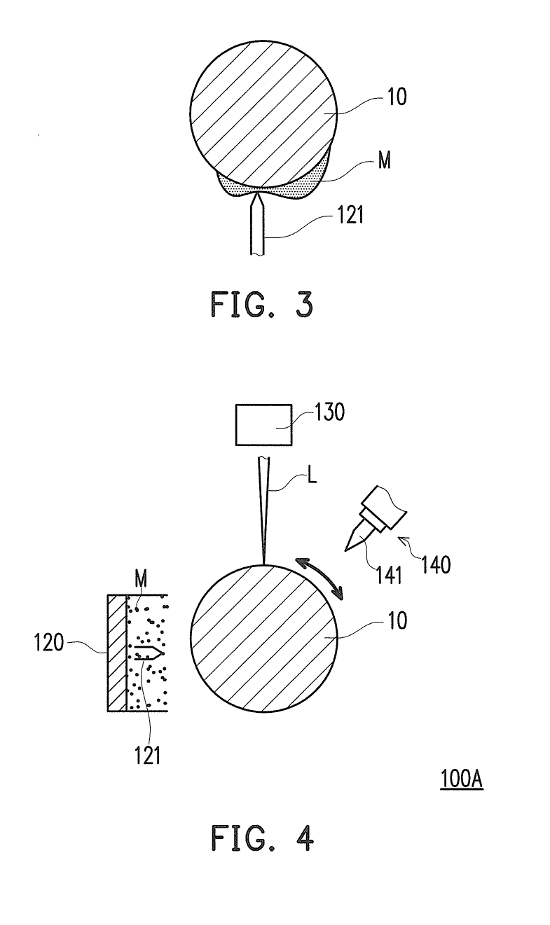

FIG. 3 is a schematic cross-sectional view illustrating the semi-finished object depicted in FIG. 1 along a sectional line I-I. With reference to FIG. 1 and FIG. 3, in the present exemplary embodiment, the material supply module 120 may include a scraping member 121, e.g., a scraper. When the charge-carrying powder material M is attached to the semi-finished object 10 through the electrostatic force, the thickness of the powder material M may not be as desired. To control the thickness and the uniformity of the stacked powder material M, the scraping member may scrape and level the powder material M attached to the semi-finished object 10. In particularly, the scraping member 121 remains still while the semi-finished object 10 is horizontally moved or rotated due to the operation of the support module 110; at this time, the semi-finished object 10 adjacent to the scraping member 121 can be moved or rotated relative to the scraping member 121, so as to scrape and level the powder material M attached to the semi-finished object 10. However, the disclosure is not limited to the exemplary embodiment described herein.

In another exemplary embodiment, if the semi-finished object 10 remains still, the scraping member 121 may be moved along the three linear movement axes, such that the scraping member 121 adjacent to the semi-finished object 10 is horizontally moved around the semi-finished object 10, so as to scrape and level the powder material M attached to the semi-finished object 10. Said effects may also be accomplished even though the semi-finished object 10 and the scraping member 121 are both moved.

In another aspect, the thickness of the powder material M may also be controlled by adjusting the electrostatic force. For instance, a large electrostatic force between the powder material M and the semi-finished object 10 allows an increase in the thickness of the powder material M attached to the semi-finished object 10, and a small electrostatic force between the powder material M and the semi-finished object 10 allows a decrease in the thickness of the powder material M attached to the semi-finished object 10. In another exemplary embodiment, the thickness of the powder material M (e.g., the polymer powder) may also be controlled by adjusting the duration during which the powder material M is attaching to the semi-finished object 10. For instance, if the rotation speed of the semi-finished object 10 is reduced, the thickness of the attached powder material M may increase; if the rotation speed of the semi-finished object 10 is increased, the thickness of the attached powder material M may decrease.

The energy source module 130 serves to supply a radiation source L (e.g., a laser light source) that irradiates the semi-finished object 10. Here, the support module 110 is adapted to rotate the semi-finished object 10 along the rotational axis A, such that the powder material M attached to the semi-finished object 10 turns to face the energy source module 130 and is irradiated by the radiation source L to form a sintered layer (not shown in FIG. 1). In order to control the thickness and the uniformity of the sintered layer, the knife 141 of the cutting and polishing module 140 may perform a cutting or polishing process on unnecessary parts of the sintered layer in an appropriate manner. Here, the energy source module 130 is, for instance, a zoom energy source module that is able to scan the surface of the semi-finished object 10 by means of a rangefinder, e.g., a laser rangefinder (not shown), so as to learn the undulation of the surface of the semi-finished object 10; thereby, the focal length of the energy source module 130 may be adjusted, and the radiation source L may be focused on the to-be-sintered region to supply the sufficient amount of energy for sintering the powder material M.

The energy source module 130 and the material supply module 120 are, for instance, configured at different spatial locations. Hence, if the semi-finished object 10 remains still, the material supply module 120 can also provide the material M to the first region R1 on the semi-finished object 10, and the energy source module 130 can irradiate the second region R2 on the semi-finished object 10, wherein the first region R1 is different from the second region R2. That is, an irradiating direction of the radiation source L is different from a direction in which the powder material M is supplied to the semi-finished object 10. In FIG. 1, the material supply module 120 and the energy source module 130 face each other, but the disclosure is not limited thereto.

In the previous exemplary embodiment, the energy source module 130 capable of providing the laser light source is introduced; however, in another exemplary embodiment, the energy source module 130 may be a plasma processing device, and the energy required for sintering the powder material M may be provided by bombarding the to-be-sintered region with use of the plasma source.

FIG. 4 is a side view of an apparatus for manufacturing a three-dimensionally shaped object according to another exemplary embodiment of the disclosure. For clear illustrations and explanations, the pushing member 111, the holder 112, and the power supply 150 depicted in FIG. 1 are omitted in FIG. 4. In the apparatus 100 depicted in FIG. 1, the material supply module 120 and the energy source module 130 are located on two respective sides of the semi-finished object 10, i.e., a 180-degree included angle is between a line connecting the material supply module 120 and the semi-finished object 10 and a line connecting the energy source module 130 and the semi-finished object 10. However, in the apparatus 100A described herein and depicted in FIG. 4, a 90-degree included angle is between the line connecting the material supply module 120 and the semi-finished object 10 and the line connecting the energy source module 130 and the semi-finished object 10, for instance. That is, the relative locations of the material supply module 120 and the energy source module 130 may be adjusted according to actual requirements, and said included angles between the line connecting the material supply module 120 and the semi-finished object 10 and the line connecting the energy source module 130 and the semi-finished object 10 should not be construed as limitations to the disclosure. To be specific, the relative locations of the material supply module 120 and the energy source module 130 are determined on the premise that the radiation source L supplied by the energy source module 130 is not blocked by the material supply module 120 and can successfully irradiate to the semi-finished object 10.

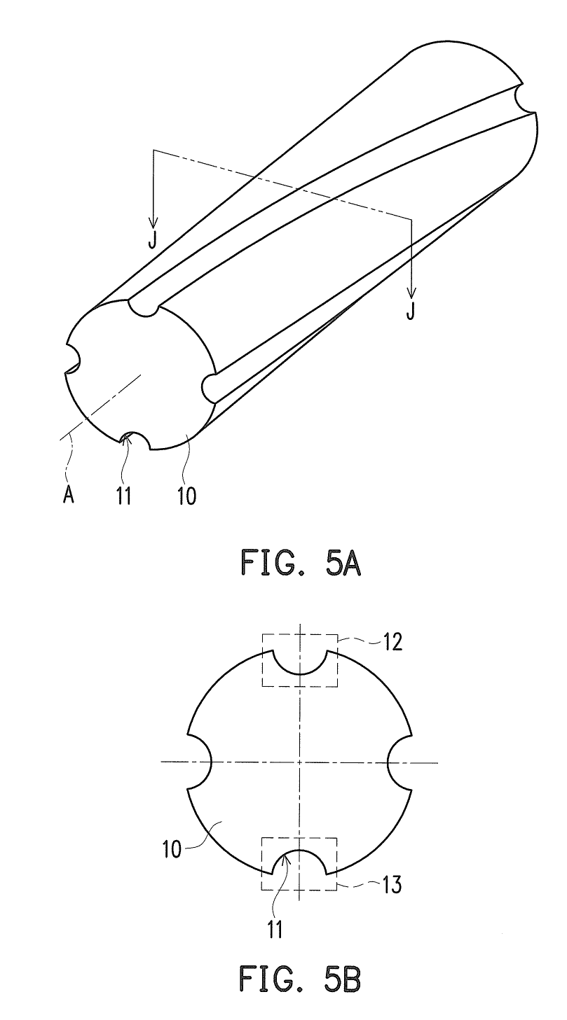

FIG. 5A is a schematic view illustrating a semi-finished object according to an exemplary embodiment of the disclosure. FIG. 5B is a schematic cross-sectional view illustrating the semi-finished object depicted in FIG. 5A along a sectional line J-J. With reference to FIG. 5A and FIG. 5B, in the present exemplary embodiment, the semi-finished object 10 has a plurality of grooves 11 formed thereon as the surface structures. According to the present exemplary embodiment, the extension direction of each of the grooves 11 is not parallel to the overall extension direction of the bar-shaped semi-finished object 10. Hence, when the semi-finished object 10 is placed on the support module 110 depicted in FIG. 1, the extension direction of each groove 11 is not parallel to the rotational axis A. Specifically, the semi-finished object 10 may be formed by mechanically processing a columnar object, i.e., the grooves 11 may be formed and shaped by the knife 141 of the cutting and polishing module 140 shown in FIG. 2. Certainly, the grooves 11 may also be formed in another way, e.g., by performing a molding process or a punching process.

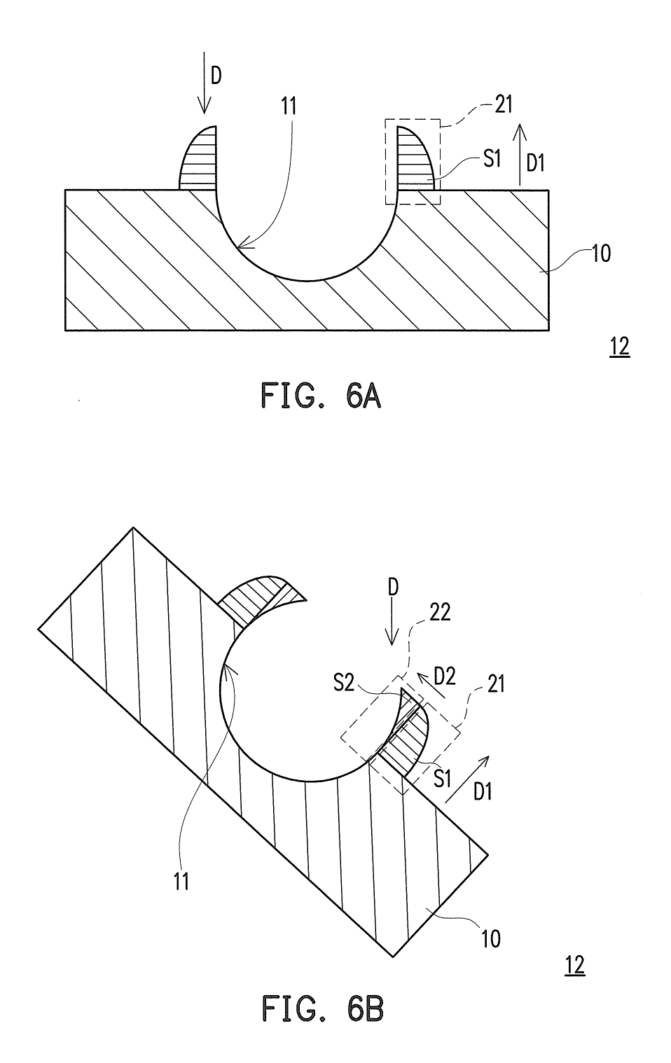

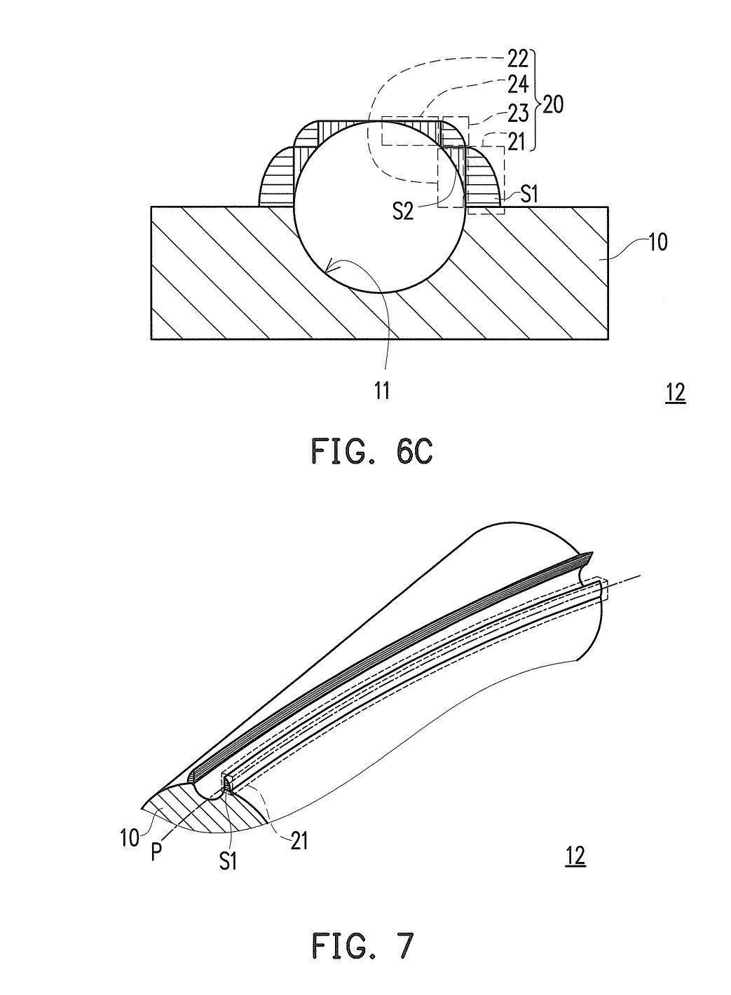

FIG. 6A to FIG. 6C are flows illustrating an additive manufacturing (AM) process performed on the first region on the semi-finished object depicted in FIG. 5B with use of an apparatus for manufacturing a three-dimensionally shaped object. FIG. 7 is a schematic three-dimensional view of FIG. 6A. With reference to FIG. 1 and FIG. 6A, if the AM process is to be performed on the first region 12, the support module 110 may rotate the semi-finished object 10 about the rotational axis A, so as to turn the first region 12 to face the material supply module 120. At this time, the powder material M in the material supply module 120 can be attached to the first region 12 of the semi-finished object 10 through the electrostatic force. After the powder material M is attached to the first region 12, the support module 110 further rotates about the rotational axis A, such that the first region 12 on the semi-finished object 10 turns to face the energy source module 130 and is irradiated by the radiation source L. In view of the above, the powder material M is attached to the semi-finished object 10 through the electrostatic force. The thickness of the powder material M on the semi-finished object 10 may be controlled by adjusting the electrostatic force or by means of the scraping member 121.

Specifically, the apparatus 100 or 100A for manufacturing a three-dimensionally shaped object includes a computation control unit (not shown) that may calculate the required data corresponding to the shape and profile of the to-be-formed object and output control signals corresponding to the calculated required data to the support module 110 and the energy source module 130, respectively. According to the control signals, the support module 110 is able to move the semi-finished object 10 along the three linear movement axes or rotate the semi-finished object 10 about the two rotational axes A and B, such that the to-be-sintered first region 12 faces the energy source module 130. The radiation source L provided by the energy source module 130 may, based on the control signals, irradiate the first region 12 and sinter the powder material M attached to the first region 12 along a predetermined path (not shown in FIG. 6A), so as to form the sintered layer.

For instance, the energy source module 130 allows the radiation source L to irradiate the powder material M attached to the first region 12 according to the control signals provided by the computation control unit. At this time, the radiation source L irradiates the powder material M attached to the first region 12 in a direction D, for instance. Thereafter, said steps of rotating the semi-finished object 10, providing the powder material M, rotating the semi-finished object 10, and providing the radiation source L are repetitively performed, so as to form a plurality of first sintered layers S1. Here, the first sintered layers S1 are stacked to form a first sintered portion 21, and a direction in which the first sintered layers S1 are stacked is parallel to a first direction D1. Certainly, the dimension and the location of each first sintered layer S1 in the first sintered portion 21 are determined according to the data input by the computation control unit.

As shown in FIG. 7, due to the five-axis flexibility of the support module 110, the first sintered layers S1 may be continuously formed on a predetermined path P on a non-planar surface.

With reference to FIG. 6B, while said steps of rotating the semi-finished object 10, providing the powder material M, rotating the semi-finished object 10, and providing the radiation source L are performed, the rotation angle of the semi-finished object 10 is different from the rotation angle determined during the manufacturing process depicted in FIG. 6A, so as to form the second sintered layers S2 with the desired shape in another step. Hence, the second sintered layers S2 are formed by irradiating the powder material in the direction D with use of the radiation source L of the energy source module 130; that is, the position of the energy source module 130 relative to the semi-finished object 10 remains still, different sintered layers are shaped by rotating the semi-finished object 10, and the required rotation angle of the semi-finished object 10 may be determined according to the data provided by the computation control unit.

In particular, said steps of rotating the semi-finished object 10, providing the powder material M, rotating the semi-finished object 10, and providing the radiation source L are repetitively performed, so as to form a plurality of second sintered layers S2. Here, the second sintered layers S2 are stacked to form a second sintered portion 22, and a direction in which the second sintered layers S2 are stacked is parallel to a second direction D2. The first direction D1 is different from the second direction D2. In the present exemplary embodiment, the first direction D1 and the second direction D2 are perpendicular to each other, i.e., the direction in which the second sintered layers S2 are stacked is perpendicular to the direction in which the first sintered layers S1 are stacked; however, the disclosure is not limited thereto. In addition, the profile of the second sintered portion 22 and the profile of the first sintered portion 11 are connected and shaped as an arc according to the present exemplary embodiment.

In FIG. 6C, said steps of rotating the semi-finished object 10, providing the powder material M, rotating the semi-finished object 10, and providing the radiation source L are repetitively performed with use of the apparatus 100 or 100A depicted in FIG. 1 or FIG. 4, and the data from the computation control unit may be applied to adjust the direction in which the energy source module 130 irradiates the semi-finished object 10 and the location irradiated by the energy source module 130, so as to form other sintered portions 23 and 24. According to the present exemplary embodiment, the first sintered portion 21, the second sintered portion 22, and the sintered portions 23 and 24 are constituted by sintered layers that are respectively stacked in different directions, and the first sintered portion 21, the second sintered portion 22, and the sintered portions 23 and 24 are connected to form the sintered structure 20. In addition, in the cross-sectional profile the sintered structure 20 and the grooves 11 are connected and shaped as successive circles. Therefore, after the manufacturing process shown in FIG. 6A to FIG. 6C is performed, the semi-finished object 10 having the grooves 11 may be transformed into the three-dimensionally shaped object with several hollow channels along the grooves 11. After the sintered structure 20 is formed, a remaining and non-sintered portion of the powder material M may still be attached to the surface of the three-dimensionally shaped object, and the remaining and non-sintered portion of the powder material may be removed by conducting a cleansing method, such as water/liquor washing or air/gas blowing.

In FIG. 6C, the cross-sectional profile of the hollow channel is circular, which should however not be construed as a limitation to the disclosure; particularly, by performing said manufacturing process, the cross-sectional profile of the internal channel may have a polygonal shape, an elliptic shape, or an irregular shape according to actual design requirements. Besides, the unnecessary parts of the resultant sintered layers may be properly cut or polished by the knife 141 of the cutting and polishing module 141 shown in FIG. 1, for instance.

In brief, before or after the sintered structures are formed, the knife of the cutting and polishing module may perform a cutting or polishing process on at least one of the semi-finished object and the sintered structures according to the data of the computation control unit. Thereby, the mechanical processing technique and the technique of forming the sintered structures may be alternately applied in the method for manufacturing the three-dimensionally shaped object, so as to accelerate the overall manufacture of the three-dimensionally shaped object. Note that the order of applying said two techniques should not be construed as a limitation to the disclosure, and the mechanical processing technique and the technique of forming the sintered structures may be applied alternately. In other words, the cutting and polishing module may perform a cutting process, a polishing process, or both on at least one of the semi-finished object and the sintered structures. According to the so-called mechanical processing technique, the surface of the three-dimensionally shaped object may be leveled and smoothed, and unnecessary parts may be cut off, so as to ensure that the resultant object has the desired profile. Hence, the cutting and polishing module described herein may serve not only to smooth the profile of the three-dimensionally shaped object but also to change the profile of the three-dimensionally shaped object from a first shape to a second shape different from the first shape.

With reference to FIG. 5, during the rotation of the semi-finished object, i.e., in the process of turning the first region 12 (to which the powder material M is attached) to face the energy source module 130, the second region 13 may approach the material supply module 120. Due to the electrostatic force, the powder material M is able to be attached to the second region 13, and the second region 13 is different from the first region 12. Meanwhile, the radiation source L may irradiate on the powder material M attached to the first region 12, and the detail process is already described above and thus will not be further demonstrated hereinafter. After the powder material M is also attached to the second region 13, the second region 13 is turned to face the energy source module 130, such that the radiation source L may irradiate on the powder material M attached to the second region 13 and sinter the powder material M. Said steps are repetitively performed to form the hollow channels (shown in FIG. 6C) in both the first region 12 and the second region 13. In the embodiment, when the powder material M is supplied to the second region 13 on the semi-finished object 10, the powder material M attached to the first region 12 may be sintered; by contrast, when the powder material M is supplied to the first region 12 on the semi-finished object 10, the powder material M attached to the second region 13 may be sintered.

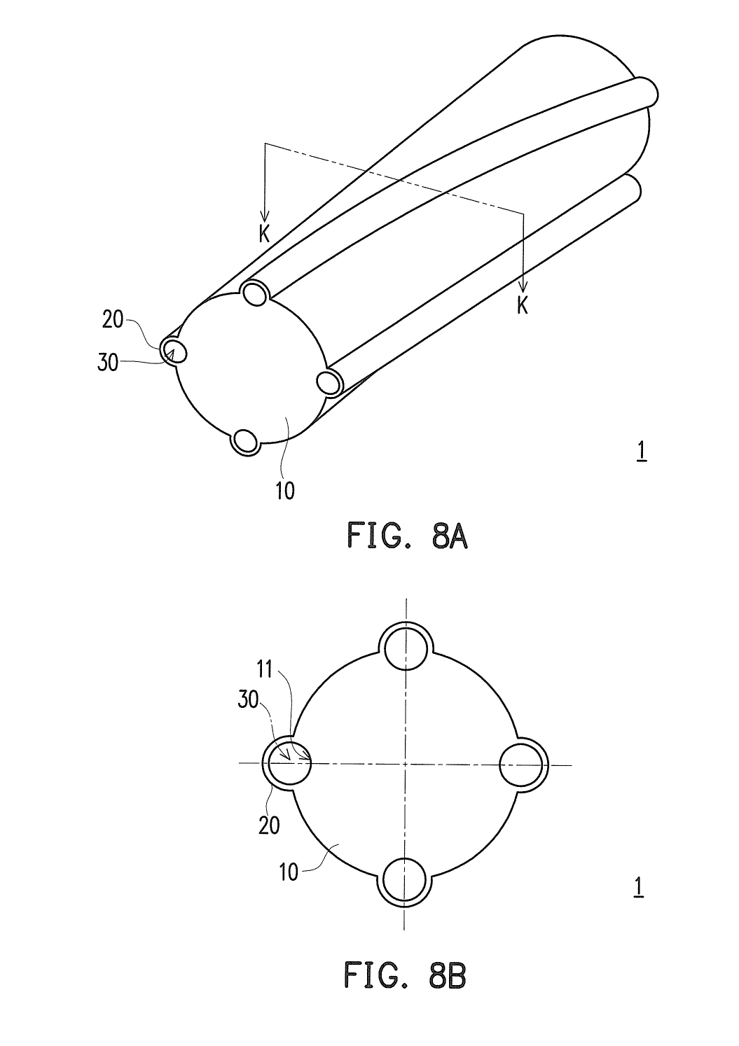

FIG. 8A illustrates a three-dimensionally shaped object formed by performing the manufacturing process depicted in FIG. 6A to FIG. 6C. FIG. 8B is a schematic cross-sectional view of FIG. 8B along a sectional line K-K. With reference to FIG. 8A and FIG. 8B, the three-dimensionally shaped object 1 includes the semi-finished object 10 and a plurality of sintered structures 20 formed on a surface of the semi-finished object 10. In light of the above, the semi-finished object 10 has a bar-shaped structure and includes a plurality of grooves 11, and the extension direction of each groove 11 is different from the overall extension direction of the semi-finished object 10. The sintered structures 20 are formed on the semi-finished object 10. Each of the sintered structures 20 includes a first sintered portion 21, a second sintered portion 22, and other sintered portions 23 and 24, as shown in FIG. 6C. The first sintered portion 21 is constituted by a plurality of first sintered layers S1 stacked on the semi-finished object 10, and the second sintered portion 22 is constituted by a plurality of second sintered layers S2 stacked on the semi-finished object 10. Here, the direction in which the first sintered layers S1 are stacked is parallel to the first direction D1, and the direction in which the second sintered layers S2 are stacked is parallel to the second direction D2. The direction in which the sintered layers of the sintered portion 23 are stacked may be the same as the direction in which the first sintered layers S1 of the first sintered portion 21 are stacked, and the direction in which the sintered layers of the sintered portion 24 are stacked may be the same as the direction in which the second sintered layers S2 of the second sintered portion 22 are stacked, which should however not be construed as a limitation to the disclosure.

The first sintered portion 21, the second sintered portion 22, and the sintered portions 23 and 24 are in contact with one another. Besides, the surface of the semi-finished object 10 (i.e., the grooves 12), the first sintered portion 21, the second sintered portion 22, and the sintered portions 23 and 24 together define a channel 30, and the extension direction of the channel 30 substantially complies with the extension direction of the grooves 12. The three-dimensionally shaped object 1 may be a cooling system or a cooling tube in a machine, for instance. Besides, the sintered structures 20 may be properly cut or polished by the knife 141 of the cutting and polishing module 140 shown in FIG. 1, for instance. From another perspective, according to actual design requirements, a material of each of said sintered portions may be the same as or different from a material of the semi-finished object 10, which should however not be construed as a limitation to the disclosure.

In the present exemplary embodiment, the desired channel 30 may be formed by creating the sinter layers stacked in different directions on the non-planar surface of the semi-finished object 10 by means of the apparatus 100 or 100A shown in FIG. 1 or FIG. 4. Although the semi-finished object 10 has a curved (non-planar) surface, corresponding sintered structures 20 may be formed in response to the predetermined design.

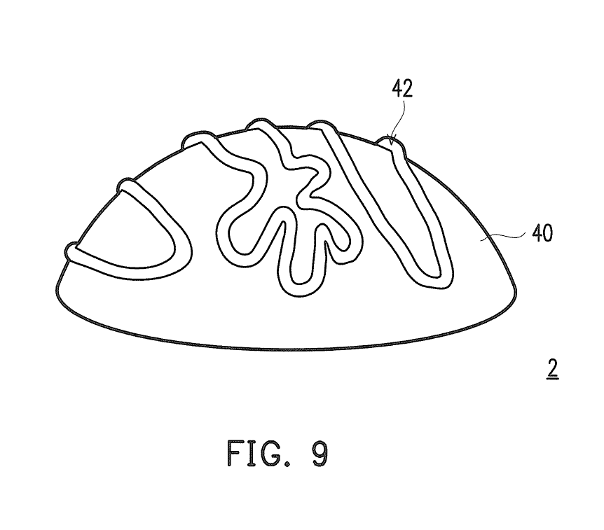

In the previous exemplary embodiment, the channels 30 are distributed along the surface of the bar-shaped semi-finished object 10; accordingly, even though the support module 110 of the apparatus 100 for manufacturing the three-dimensionally shaped object is characterized by the five-axis flexibility, the support module 110 described herein may merely rotate along the rotational axis A. However, based on different design requirements, a desired three-dimensionally shaped object can be formed by using the support module 110 characterized by the five-axis flexibility, i.e., the movement along the three linear movement axes and the rotation about the two rotational axes A and B. For instance, FIG. 9 illustrates a three-dimensionally shaped object formed by employing an apparatus for manufacturing a three-dimensionally shaped object according to another exemplary embodiment of the disclosure. With reference to FIG. 9, the three-dimensionally shaped object 2 includes the semi-finished object 40 and a plurality of sintered structures 42, and the semi-finished object 40 has a spherical shape. When the apparatus 100 for manufacturing the three-dimensionally shaped object is applied to form the sintered structures 42, the five-axis flexibility of the support module 110 in the apparatus 100 allows the resultant sintered structure to be distributed along the spherical surface of the semi-finished object 40 in a zigzag-like manner.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. An apparatus for manufacturing a three-dimensionally shaped object, the apparatus comprising:
a support module adapted to hold a semi-finished object;
a material supply module supplying a powder material and attaching the powder material to a surface of the semi-finished object; and
an energy source module supplying a radiation source irradiating the semi-finished object, wherein the support module is adapted to rotate the semi-finished object, such that the powder material attached to the semi-finished object turns to face the energy source module and is irradiated by the radiation source to form a sintered layer, and the powder material is constantly attached to the semi-finished object while the semi-finished object is rotated.

2. The apparatus as recited in claim 1, wherein the support module is adapted to rotate the semi-finished object along a plurality of axial directions.

3. The apparatus as recited in claim 1, wherein the surface of the semi-finished object is non-planar.

4. The apparatus as recited in claim 1, further comprising a power supply electrically coupled between the support module and the material supply module, wherein when the semi-finished object approaches the material supply module, the powder material is attached to the semi-finished object through an electrostatic force.

5. The apparatus as recited in claim 1, wherein the support module comprises a pushing member and a holder, and the semi-finished object is held by and fixed between the pushing member and the holder.

6. The apparatus as recited in claim 1, wherein the material supply module comprises a scraping member for scraping and leveling the powder material attached to the semi-finished object.

7. The apparatus as recited in claim 1, wherein the energy source module is a zoom energy source module.

8. The apparatus as recited in claim 1, wherein an irradiating direction of the radiation source is different from a direction in which the powder material is supplied to the semi-finished object.

9. The apparatus as recited in claim 1, further comprising a cutting and polishing module adapted to perform a cutting or polishing process on at least one of the semi-finished object and the sintered layer.

10. A method for manufacturing a three-dimensionally shaped object, the method comprising:
providing the apparatus as recited in claim 1;
rotating the semi-finished object by the support module, such that the powder material from the material supply module is attached to a first region on the semi-finished object; and
rotating the semi-finished object by rotating the support module, such that the first region turns to face the energy source module and is irradiated by the radiation source, and sintering the powder material attached to the first region along a predetermined path, so as to form the sintered layer.

11. The method as recited in claim 10, further comprising repetitively performing the step of forming the sintered layer to form a plurality of first sintered layers, the first sintered layers being stacked to form a first sintered portion, and a direction in which the first sintered layers are stacked being parallel to a first direction.

12. The method as recited in claim 11, further comprising repetitively performing the step of forming the sintered layer to form a plurality of second sintered layers, the second sintered layers being stacked to form a second sintered portion, and a direction in which the second sintered layers are stacked being parallel to a second direction, wherein the first direction is different from the second direction.

13. The method as recited in claim 10, further comprising:
performing a cutting or polishing process on at least one of the semi-finished object and the sintered layer with use of a cutting and polishing module.

14. The method as recited in claim 10, further comprising respectively supplying charges to the semi-finished object held by the support module and the powder material held by the material supply module through a power supply electrically coupled between the support module and the material supply module, wherein when the semi-finished object approaches the material supply module, the powder material is attached to the semi-finished object through an electrostatic force.

15. The method as recited in claim 10, wherein when the support module rotates the semi-finished object, the support module is adapted to rotate the semi-finished object along a plurality of axial directions.

16. The method as recited in claim 10, further comprising:
placing a scraping member on the material supply module for scraping and leveling the powder material attached to the surface of the semi-finished object.

17. The method as recited in claim 10, wherein after sintering the powder material attached to the first region to form the sintered layer, the method further comprises:
removing a remaining and non-sintered portion of the powder material from the semi-finished object.

18. The method as recited in claim 17, wherein a method of removing the remaining and non-sintered portion of the powder material comprises a cleansing method.

19. The method as recited in claim 10, further comprising rotating the semi-finished object and attaching the powder material to a second region on the semi-finished object, wherein the second region is different from the first region.

20. The method as recited in claim 19, wherein after the powder material is attached to the second region, the method further comprises turning the second region to face the energy source module to sinter the powder material attached to the second region.

21. The method as recited in claim 19, wherein while the powder material is attached to the second region, the radiation source irradiates and sinters the powder material attached to the first region.

22. A three-dimensionally shaped object comprising:
a semi-finished object; and
a plurality of sintered structures formed on the semi-finished object, each of the sintered structures comprising:
a first sintered portion constituted by a plurality of first sintered layers stacked on the semi-finished object, wherein a direction in which the first sintered layers are stacked is parallel to a first direction; and
a second sintered portion constituted by a plurality of second sintered layers stacked on the semi-finished object, wherein a direction in which the second sintered layers are stacked is parallel to a second direction, and the second direction is different from the first direction.

23. The three-dimensionally shaped object as recited in claim 22, wherein the first sintered portion and the second sintered portion are in contact with each other.

24. The three-dimensionally shaped object as recited in claim 22, wherein a surface of the semi-finished object, the first sintered portion, and the second sintered portion together define a channel.

25. The three-dimensionally shaped object as recited in claim 22, wherein a surface of the semi-finished object is non-planar.

26. The three-dimensionally shaped object as recited in claim 22, wherein a material of at least one of the first and second sintered portions is different from a material of the semi-finished object.

27. The three-dimensionally shaped object as recited in claim 22, wherein a material of the first and second sintered portions is identical to a material of the semi-finished object.
